(19) United States
(12) Patent Application Publication
(10) Pub. No.: US 2016/0350147 A1
(43) Pub. Date: Dec. 1, 2016

(54) CONTROL METHOD AND CONTROL DEVICE

(71) Applicant: FUJITSU LIMITED, Kawasaki-shi (JP)

(72) Inventors: Hiroki SUMIDA, Mishima (JP); Yasuo Yoshimoto, Numazu (JP)

(73) Assignee: FUJITSU LIMITED, Kawasaki-shi (JP)

(21) Appl. No.: 15/070,438

(22) Filed: Mar. 15, 2016

(30) Foreign Application Priority Data
May 28, 2015 (JP) 2015-108187

(51) Int. Cl. G06F 9/455; G06F 9/48

(52) U.S. Cl. CPC G06F 9/45558; G06F 9/48

(57) ABSTRACT

A control method includes acquiring result information including first timings and second timings, the first timings indicating time when each of a plurality of virtual machines started on an information processing device, and the second timings indicating time when each of the plurality of virtual machines ended, executing predictions regarding each of the plurality of virtual machines running on the information processing device, for each of periods, based on the result information, when a start of a new virtual machine on the information processing device is requested, determining for each of the periods whether the start of the new virtual machine is permitted based on a result of the predictions, by a processor, and when it is determined that the start is permitted, starting the new virtual machine on the information processing device.

### CROSS-REFERENCE TO RELATED APPLICATION

This application is based upon and claims the benefit of priority of the prior Japanese Patent Application No. 2015-108187, filed on May 28, 2015, the entire contents of which are incorporated herein by reference.

1. FIELD

The embodiments discussed herein are related to deployment techniques of machines.

### BACKGROUND

It is possible to promote energy saving and resource saving by integrating physical machines using virtualization. However, if the amount of memory equal to or larger than the memory capacity of the physical machines is assigned to the virtual machines running on the physical machines, a memory over-commitment occurs, and the performance of the virtual machines is deteriorated. Accordingly, operations are normally carried out such that virtual machines are deployed in the range of the memory capacity installed on the physical machines.

On the other hand, in a private cloud environment for software development, or the like, actual situations are confirmed in which a virtual machine is left unused for a long time. In such a case, if the unused virtual machine is stopped to release the memory, and then the released memory is assigned to another virtual machine, it is possible to use resources more effectively. However, when a plurality of users use the same virtual machine, it is sometimes not possible for each user to determine whether or not the user is allowed to stop the virtual machine. Accordingly, for example, an operation schedule for running a virtual machine is made in accordance with a working time frame for general workers in advance, and the power source control of virtual machines is automatically performed in accordance with the schedule.

Also, in a related-art technique on the deployment of virtual machines, loads occurring in the virtual machines are obtained based on a scheduled time to start operation and a scheduled time to stop operation, and physical machines on which virtual machines are deployed are determined based on the loads.

A related technique is disclosed in International Publication Pamphlet No. WO 2012/117453, for example.

### SUMMARY

According to an aspect of the invention, a control method includes acquiring result information including first timings and second timings, the first timings indicating time when each of a plurality of virtual machines started on an information processing device, and the second timings indicating time when each of the plurality of virtual machines ended, executing predictions regarding each of the plurality of virtual machines running on the information processing device, for each of periods, based on the result information, when a start of a new virtual machine on the information processing device is requested, determining for each of the periods whether the start of the new virtual machine is permitted based on a result of the predictions, by a processor, and when it is determined that the start is permitted, starting the new virtual machine on the information processing device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a system overview;

FIG. 2 is a hardware configuration diagram of a physical machine;

FIG. 3 is a functional block diagram of the physical machine;

FIG. 4 is a flowchart illustrating power control processing of a virtual machine in accordance with a schedule;

FIG. 5 is a diagram illustrating an example of schedule data stored in a second data storage unit;

FIG. 6 is a flowchart of the processing executed by a physical machine that has received a deployment request;

FIG. 7 is a flowchart of calculation processing;

FIG. 8 is a flowchart of complement processing;

FIG. 9 is a diagram illustrating operation result data on turning off the power;

FIG. 10 is a diagram illustrating operation result data on turning on the power;

FIG. 11 is a diagram illustrating an example of an operation result of a certain virtual machine;

FIG. 12 is a diagram illustrating an example of data on a CPU use rate;

FIG. 13 is a diagram illustrating an example of an operation result;

FIG. 14 is a diagram illustrating an example of extraction of a time frame;

FIG. 15 is a diagram illustrating an example of extraction of a time frame;

FIG. 16 is a diagram illustrating an example of extraction of a time frame;

FIG. 17 is a diagram illustrating an example of operation prediction data;

FIG. 18 is a flowchart of calculation processing;

FIG. 19 is a diagram illustrating an example of memory assignment information stored in a first data storage unit;

FIG. 20 is a diagram illustrating an example of physical machine information stored in the first data storage unit;

FIG. 21 is a diagram illustrating an example of memory capacity data; and

FIG. 22 is a diagram illustrating an example of a message to be displayed.

### DESCRIPTION OF EMBODIMENTS

In an environment in which a virtual machine is started and stopped depending on a user or by automatic power source control, if a memory that has been released by a stop of a virtual machine is assigned to a new virtual machine, a memory over-commitment sometimes occurs. This is because if a stopped virtual machine is restarted, a memory has to be assigned to that virtual machine.

Accordingly, in order to avoid performance deterioration, it is preferable to assign a sufficient amount of resources to a virtual machine. However, if operation is performed by simply assigning a large amount of resources to the virtual machine, it is not possible to effectively use the resources.

Also, in a technique for determining a physical machine on which virtual machines are deployed based on the load, it is assumed that an operation schedule of each of the virtual machines is determined. Accordingly, the technique is not effective for an environment in which there are some virtual machines not having fixed operation schedules.

With a disclosed technique according to the present embodiment, it is possible to restrain depletion of resources in an operation environment of a virtual machine.

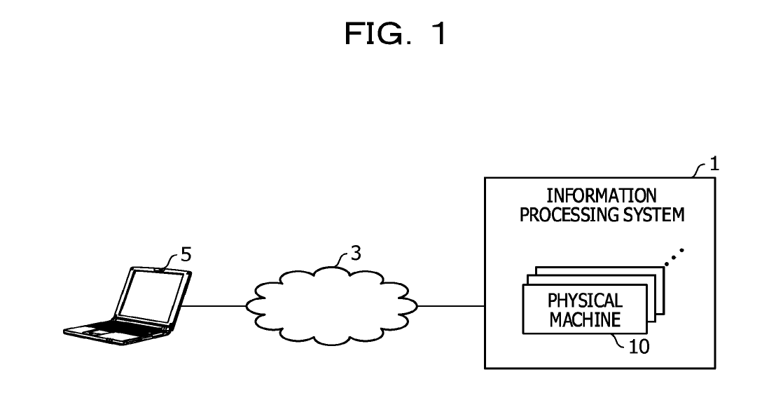

FIG. 1 illustrates a system overview according to the present embodiment. For example, an information processing system 1 and a user terminal 5 are coupled to a network 3, which is the Internet. The information processing system 1 includes a plurality of physical machines 10. Each of the physical machines 10 performs deployment of a virtual machine in accordance with a request received from the user terminal 5 and also performs power source control of the virtual machine in accordance with a predetermined schedule.

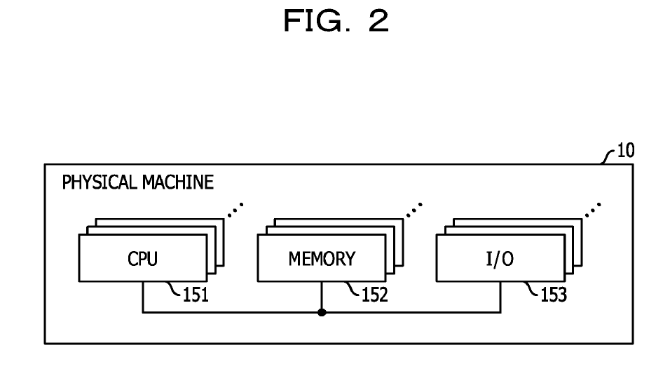

FIG. 2 is a hardware configuration diagram of the physical machine 10. The physical machine 10 includes one or a plurality of central processing units (CPUs) 151, one or a plurality of memories 152, one or a plurality of inputs/outputs (I/Os) 153. The I/O 153 is a physical port, or the like, for example. The CPU 151, the memory 152, and the I/O 153 are coupled by a bus.

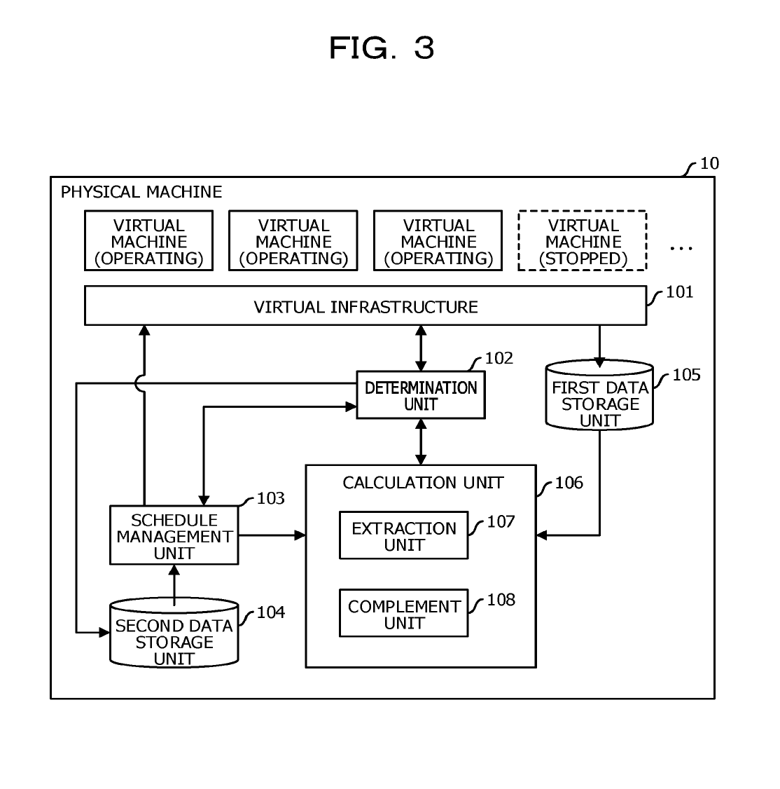

The program for executing the processing according to the present embodiment is loaded in the memory 152, and is executed by the CPU 151 to achieve various functions illustrated in FIG. 3. FIG. 3 illustrates a functional block diagram of the physical machine 10. The physical machine 10 includes a virtual infrastructure 101, a determination unit 102, a schedule management unit 103, a first data storage unit 105, a second data storage unit 104, and a calculation unit 106. The calculation unit 106 includes an extraction unit 107 and a complement unit 108.

The virtual infrastructure 101 is a hypervisor, for example, and allows one or a plurality of virtual machines to operate on the virtual infrastructure 101. Each virtual machine is in an operating state or a stop state. The virtual infrastructure 101 stores its managed data (for example, operation result data and data on the CPU use rate, or the like) in the first data storage unit 105. The virtual infrastructure 101 controls the power source of the virtual machines based on a notification from the schedule management unit 103.

The schedule management unit 103 executes processing based on the schedule data stored in the second data storage unit 104, and notifies the virtual infrastructure 101 of the processing result. The schedule management unit 103 passes schedule data for each virtual machine to the calculation unit 106. If the schedule management unit 103 receives a deployment request, which requests deployment of a new virtual machine, from the user terminal 5, the schedule management unit 103 notifies the determination unit 102 of information on the memory capacity to be assigned to the new virtual machine, which is included in the received deployment request. If the schedule management unit 103 is notified that the new virtual machine is not allowed to be deployed from the determination unit 102, the schedule management unit 103 transmits a response message to the deployment request received from the user terminal 5 to the user terminal 5.

If a part of the operation result data stored in the first data storage unit 105 is missing, the complement unit 108 in the calculation unit 106 complements the missing part of the operation result data based on the data of the CPU use rate stored in the first data storage unit 105. The extraction unit 107 in the calculation unit 106 generates data (hereinafter referred to as operation prediction data) indicating the future operation period for each virtual machine based on the operation result data stored in the first data storage unit 105. The calculation unit 106 generates time-series data of the memory capacity available in the physical machine 10 based on the operation prediction data of each virtual machine generated by the extraction unit 107 and the data stored in the first data storage unit 105, and passes the data to the determination unit 102.

The determination unit 102 determines whether or not it is possible for a new virtual machine to be deployed on the physical machine 10 based on the data received from the calculation unit 106 and the data received from the schedule management unit 103. If it is possible for the new virtual machine to be deployed on the physical machine 10, the determination unit 102 deploys the new virtual machine on the virtual infrastructure 101. If the new virtual machine is not possible to be deployed on the physical machine 10, the determination unit 102 notifies the schedule management unit 103 that the new virtual machine is not possible to be deployed.

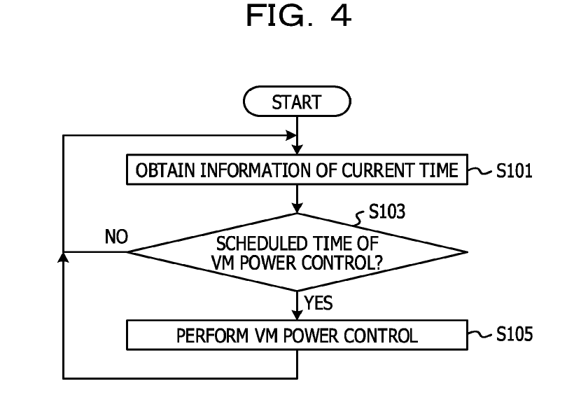

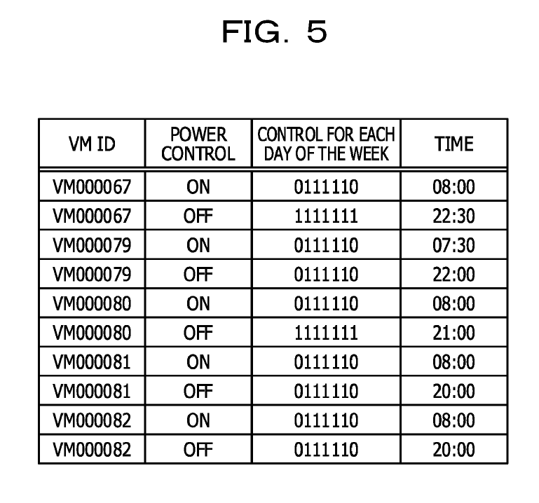

Next, a description will be given of processing executed by the physical machine 10 using FIG. 4 to FIG. 22. First, a description will be given of processing for controlling the power source of the virtual machine in accordance with the schedule using FIG. 4 and FIG. 5. In the drawings used in the following description, a virtual machine is abbreviated as a VM.

The schedule management unit 103 of the physical machine 10 obtains current time information from the system clock, for example (FIG. 4: step S101).

The schedule management unit 103 reads schedule data from the second data storage unit 104 and determines whether or not the current time is the scheduled time of the power source control of the virtual machine (step S103).

FIG. 5 illustrates an example of schedule data stored in the second data storage unit 104. In the example in FIG. 5, the schedule data includes an identifier (ID) of a virtual machine, information indicating the type of the power source control, control information indicating whether or not power source control is performed on each day of the week, and time information. Concerning the type of power source control, “ON” denotes a start of a virtual machine, and “OFF” denotes a stop of a virtual machine. The control information indicates whether or not power source control is performed on Sunday, Monday, Tuesday, Wednesday, Thursday, Friday, and Saturday. For example, the first row record indicates that a virtual machine “VM000067” is started at 08:00 from Monday to Friday. The schedule data is created by an administrator or a user of the information processing system 1 in advance, and is stored in the second data storage unit 104.

Referring back to FIG. 4, if the current time is not a scheduled time of the power source control of a virtual machine (step S103: No route), the processing returns to the processing of step S101. If the current time is the scheduled time of power source control of the virtual machine (step S103: Yes route), the schedule management unit 103 outputs an execution instruction of power source control of a virtual machine to the virtual infrastructure 101. The virtual infrastructure 101 controls the power source of the virtual machine in accordance with the execution instruction (step S105). The processing then returns to the processing of step S101.

As described above, if power source control of the virtual machine is performed in accordance with the schedule determined in consideration of a pattern of a start and a stop of a virtual machine, or the like, it becomes possible to suppress the occurrence of the situation in which the resources run significantly short.

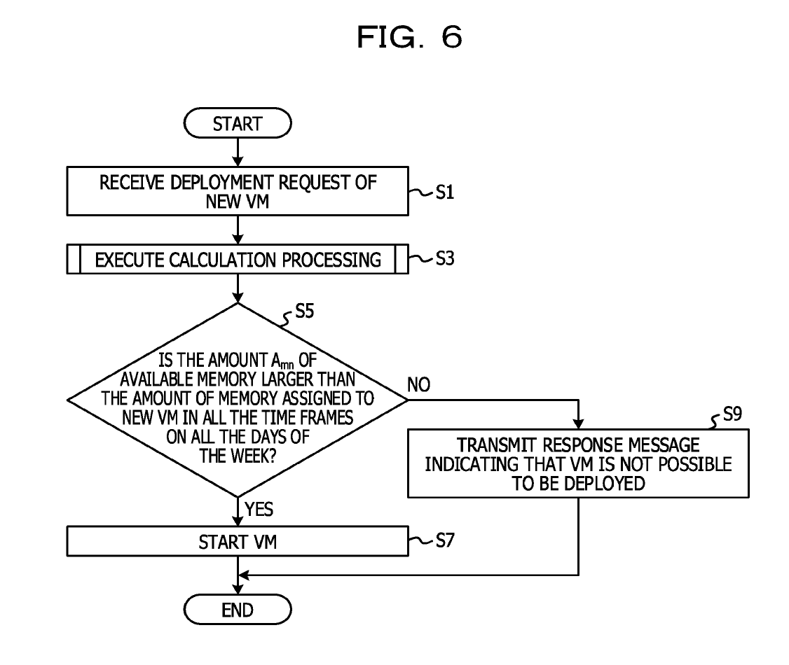

Second, a description will be given of processing executed when a deployment request is received from the user terminal 5 using FIG. 6 to FIG. 22.

The schedule management unit 103 of the physical machine 10 receives a deployment request of a new virtual machine from the user terminal 5 (FIG. 6: step 51). The schedule management unit 103 notifies the determination unit 102 of the information on the memory capacity assigned to the new virtual machine, which is included in the received deployment request. Also, the schedule management unit 103 notifies the calculation unit 106 of the receipt of the deployment request.

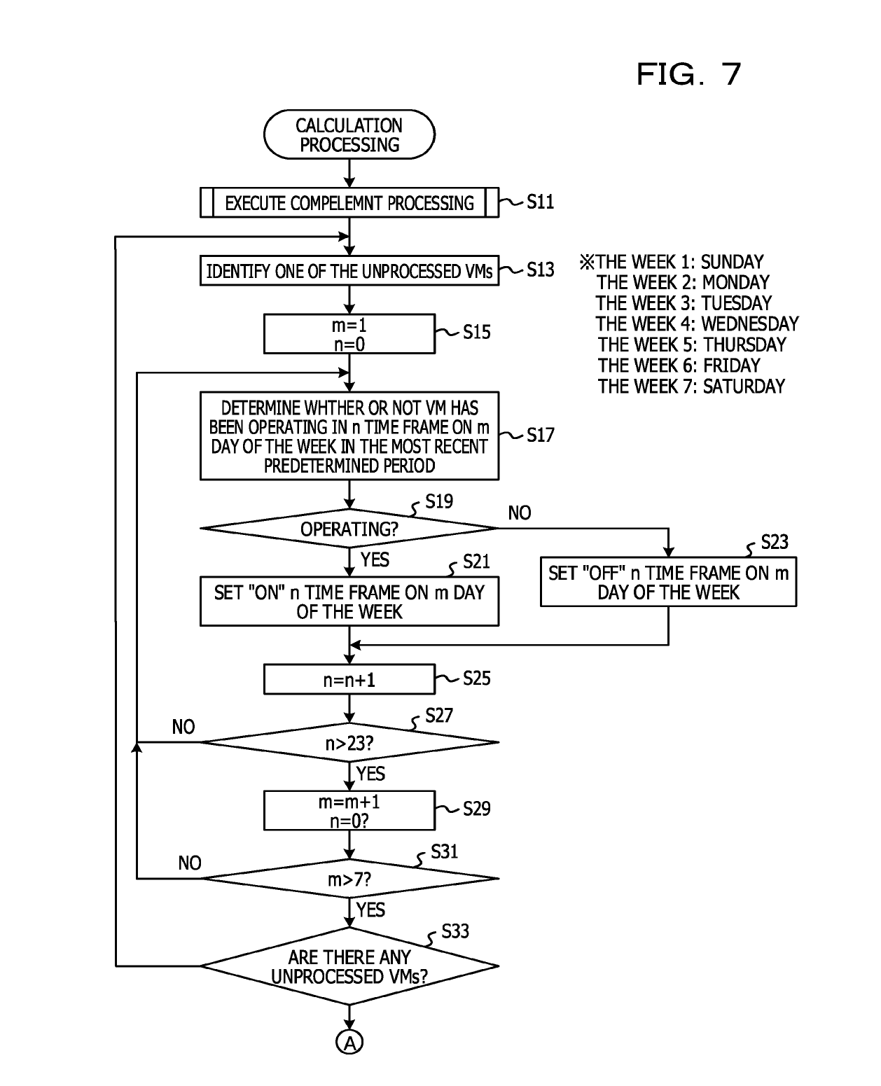

In response to this, the calculation unit 106 executes calculation processing (step S3). A description will be given of the calculation processing using FIG. 7 to FIG. 21.

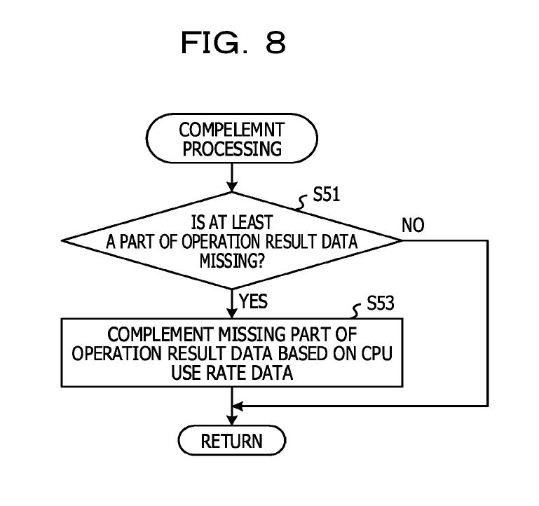

The complement unit 108 in the calculation unit 106 executes complement processing (FIG. 7: step S11). A description will be given of the complement processing using FIG. 8 to FIG. 12.

The complement unit 108 determines whether or not at least a part of the operation result data stored in the first data storage unit 105 is missing (FIG. 8: step S51).

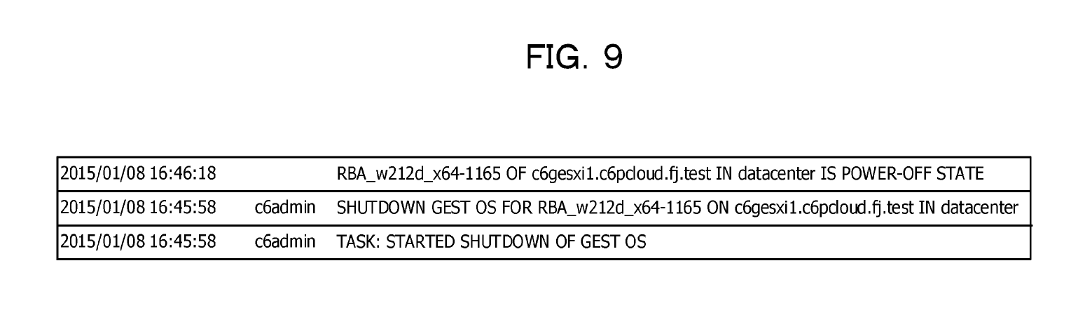

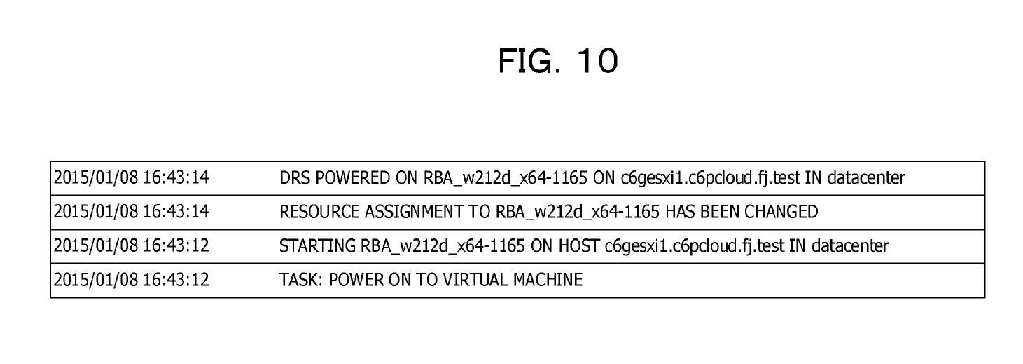

FIG. 9 and FIG. 10 illustrate examples of the operation result data, respectively. FIG. 9 is a diagram illustrating an example of the operation result data concerning turning off the power. FIG. 10 is a diagram illustrating an example of the operation result data concerning turning on the power.

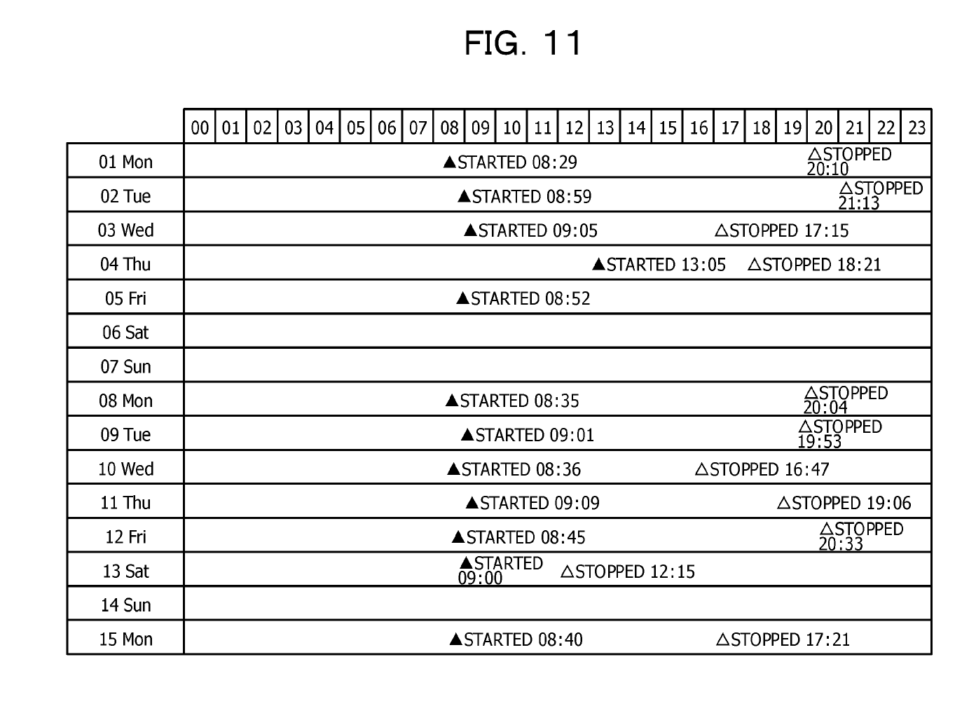

A description will be given of a missing part using FIG. 11. FIG. 11 illustrates an example of an operation result of a certain virtual machine. FIG. 11 illustrates start times and stop times of a certain virtual machine from the 01-th day Monday to the 15-th day Monday. In this regard, if an error has occurred in a virtual machine, or the like, it is sometimes not possible for the virtual infrastructure 101 to obtain its operation result data. In the example in FIG. 11, the virtual machine started at 08:52 on the 05-th day Friday, and then restarted at 08:35 on the 08-th day Monday. Thus, the virtual machine ought to have stopped once between 08:52 on the 05-th day Friday and 08:35 on the 08-th day Monday. Accordingly, it is possible to determine that a part of the operation result data is missing.

Referring back to FIG. 8, if there is no missing in the operation result data (step S51: No route), the processing returns to the calling source processing (FIG. 7). On the other hand, if at least a part of the operation result data is missing (step S51: Yes route), the complement unit 108 complements the missing part of the operation result data based on the CPU use rate data stored in the first data storage unit 105 (step S53). The processing then returns to the calling source processing (FIG. 7).

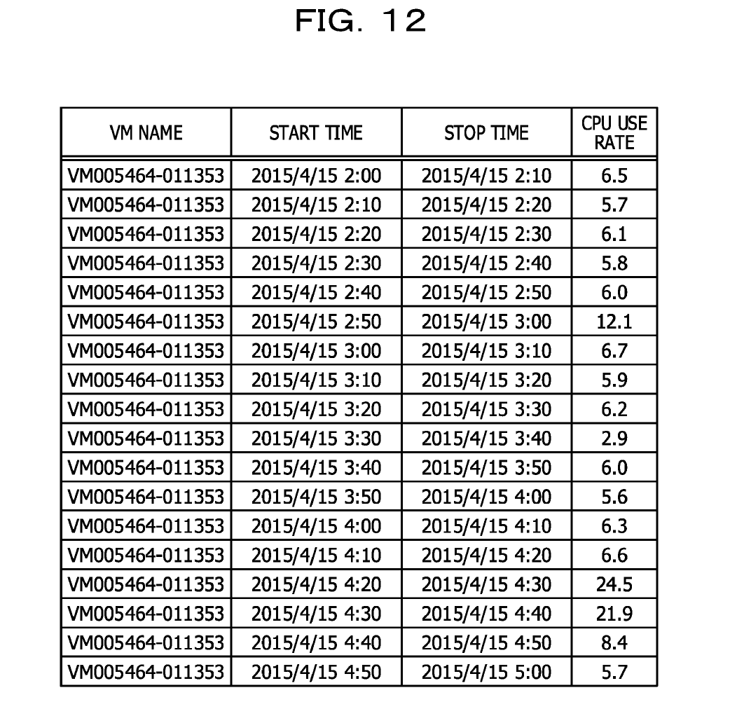

FIG. 12 illustrates an example of CPU use rate data. In the example in FIG. 12, the CPU use rate data includes a virtual machine name, measurement start time, measurement end time, and information on the CPU use rate (for example, the average value in the measurement period) of a virtual machine. If the CPU use rate is higher than a predetermined value (for example, 0), it is thought that the virtual machine is in operation. Thus, the complement unit 108 generates data including start time and end time of the time frame having a CPU use rate higher than a predetermined value for the missing part, and adds the data to the operation result data.

Referring back to FIG. 7, the extraction unit 107 identifies one of the unprocessed virtual machines among the virtual machines in operation or stopped on the physical machine 10 (step S13). The extraction unit 107 then sets a variable m indicating a day of the week so that m=1, and sets a variable n indicating a time frame so that n=0 (step S15). In this regard, it is assumed that the extraction unit 107 has obtained a list of virtual machines in operation or stopped on the physical machine 10 from the virtual infrastructure 101 in advance.

The extraction unit 107 determines whether or not the virtual machine identified in step S13 (hereinafter referred to as a virtual machine to be processed) has been operating in the n time frame (n time frame is a time frame from 00 minutes past n to 59 minutes past n) on the day of the week m in the most recent predetermined period based on the operation result data and the data added to the operation result data (step S17). Here, it is assumed that the day of the week 1 is Sunday, the day of the week 2 is Monday, the day of the week 3 is Tuesday, the day of the week 4 is Wednesday, the day of the week 5 is Thursday, the day of the week 6 is Friday, and the day of the week 7 is Saturday. If the operation of a virtual machine is started or stopped in the middle of the n time frame, the virtual machine is considered to have been operating in the n time frame.

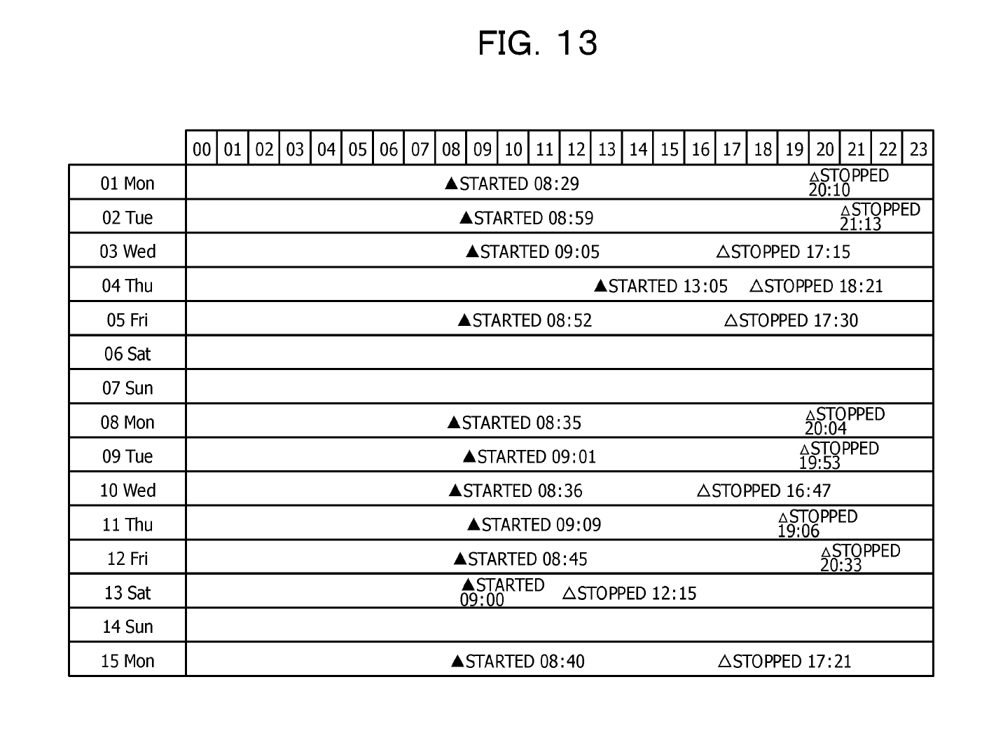

A detailed description will be given of step S17 using a specific example. For example, it is assumed that the operation result of the virtual machine to be processed is the operation result in FIG. 13. FIG. 13 illustrates start time and stop time of the virtual machine to be processed from the 01-th day Monday to the 15-th day Monday. Here, a predetermined period is two weeks.

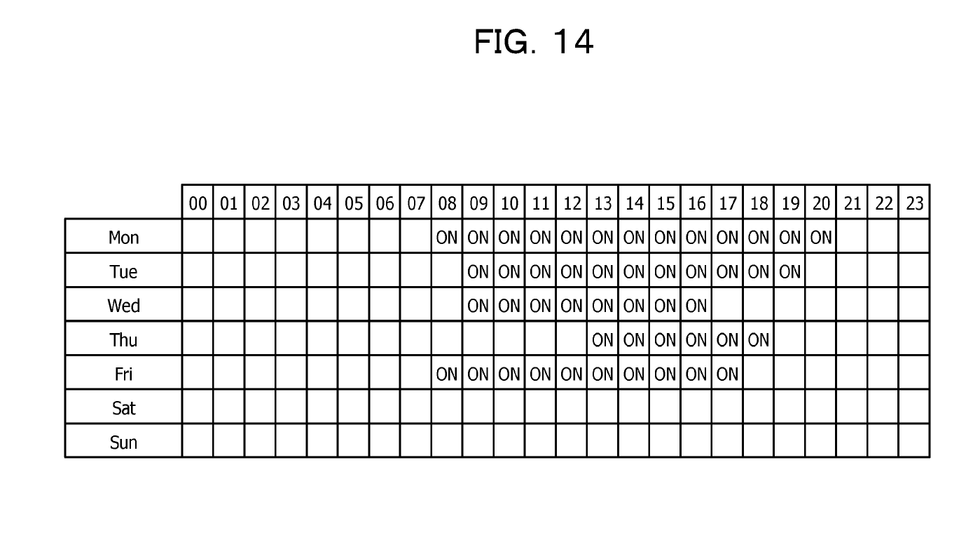

In this case, when time frames in which the virtual machine was operated in both the first week and the second week are extracted on each day of the week, the result becomes as illustrated in FIG. 14. In FIG. 14, if a virtual machine was operated in each time frame on each day of the week, “ON” is set, and if a virtual machine was not operated, the corresponding cell is blank.

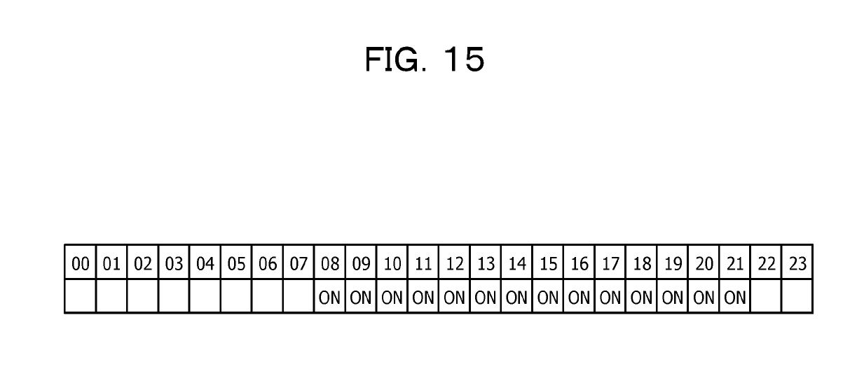

In order to extract more time frames than those in FIG. 14, when time frames in which the virtual machine operated at least once are extracted regardless of the day of the week, the result becomes a state as illustrated in FIG. 15. In FIG. 15, if the virtual machine was operated, “ON” is set for each time frame, and if the virtual machine was not operated, the corresponding cell is blank.

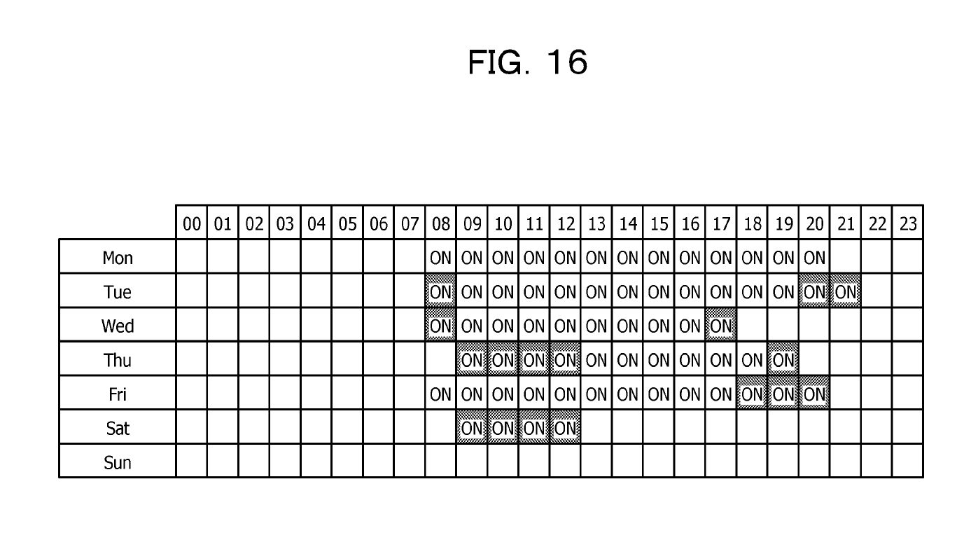

As an intermediate method between the method in FIG. 14 and the method in FIG. 15, a method of extracting time frames in which the virtual machine was operated at least once for each day of the week is considered. If time frames are extracted by this method, the result becomes a state as illustrated in FIG. 16. In FIG. 16, if the virtual machine was operated in each time frame on each day of the week, “ON” is set, and if the virtual machine was not operated, the corresponding cell is blank. In FIG. 16, a hatched cell is a cell in the time frame not extracted in the example in FIG. 14.

In this regard, the extraction unit 107 may set “ON” in the time frame that is scheduled to operate the virtual machine based on the schedule data received from the schedule management unit 103. In this manner, even if not so much time has passed from when the virtual machine was started, and thus sufficient operation result data has not been obtained, or the like, it becomes possible to suitably perform the extraction.

Also, if a predetermined period is set to one week, it is possible to attach importance to the recent trend of users without being influenced by the operation results that are equal to or older than one week.

Referring back to FIG. 7, if the virtual machine to be processed was operated in the n time frame on the day of the week m in the most recent predetermined period (step S19: Yes route), the extraction unit 107 sets “ON” the n time frame on the day of the week m (step S21). On the other hand, if the virtual machine to be processed was not operated in the n time frame on the day of the week m in the most recent predetermined period (step S19: No route), the extraction unit 107 sets “OFF” the n time frame on the day of the week m (step S23).

The extraction unit 107 increments n by 1 (step S25), and determines whether or not n>23 holds (step S27). If n>23 does not hold (step S27: No route), the processing returns to the processing of step S17. On the other hand, if n>23 holds (step S27: Yes route), the extraction unit 107 increments m by 1, and sets n to 0 (step S29), and determines whether or not m >7 holds (step S31).

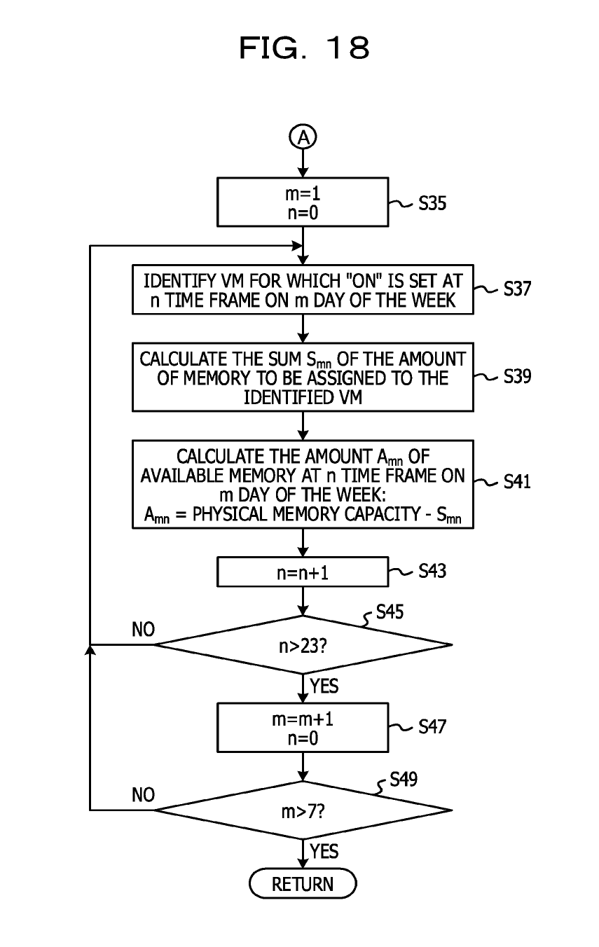

If m>7 does not hold (step S31: No route), the processing returns to the processing of step S17. On the other hand, if m>7 holds (step S31: Yes route), the extraction unit 107 determines whether or not there are unprocessed virtual machines (step S33). If there is an unprocessed virtual machine (step S33: Yes route), the processing returns to step S13. On the other hand, there are no unprocessed virtual machines (step S33: No route), the processing proceeds to step S35 in FIG. 18 through connector A.

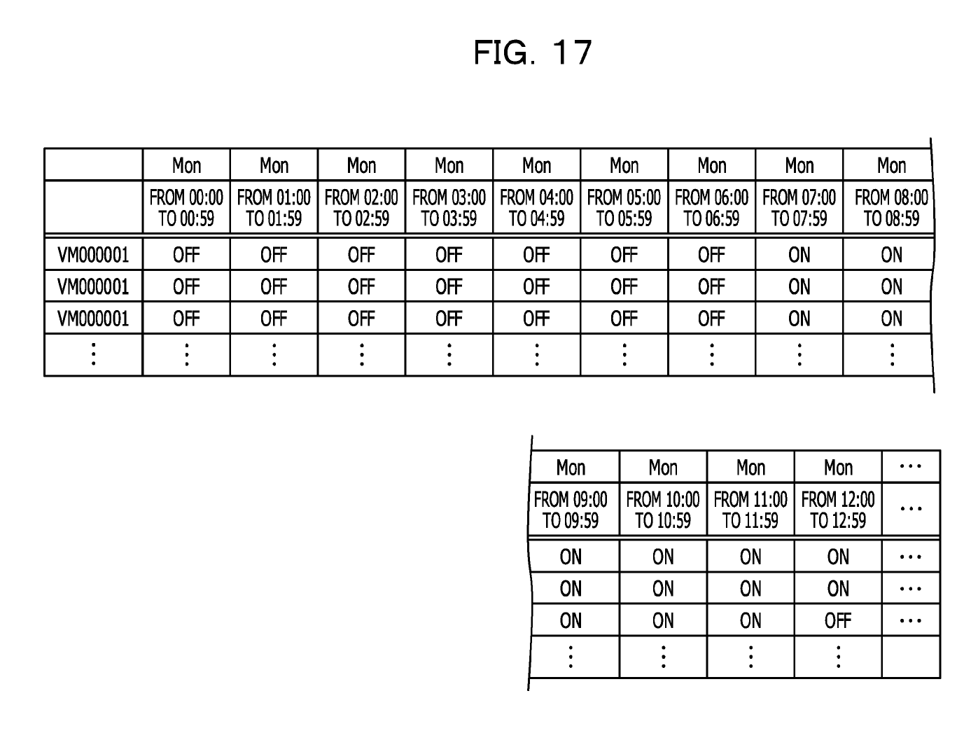

With the processing so far, the operation prediction data illustrated in FIG. 17 is generated. In the example in FIG. 17, information indicating whether or not each virtual machine operates in each time frame on each day of the week is stored. In the example in FIG. 17, only the data on Monday is illustrated. However, in reality, data on all the days of the week is generated. In this manner, in the present embodiment, the possibility of performing operation in the future is estimated from the past operation result in each time frame (that is to say, operation prediction is performed). In this regard, the generated operation prediction data is stored in the memory 152.

Referring to FIG. 18, the calculation unit 106 sets so that m=1 and n=0 (FIG. 18: step S35), and identifies a virtual machine for which “ON” is set in the n time frame on the day of the week m from the operation prediction data (step S37).

The calculation unit 106 calculates the sum Sₘₙ of the memory capacities to be assigned to the virtual machine identified in step S37 based on the information on the virtual machine identified in step S37, and the memory assignment information stored in the first data storage unit 105 (step S39).

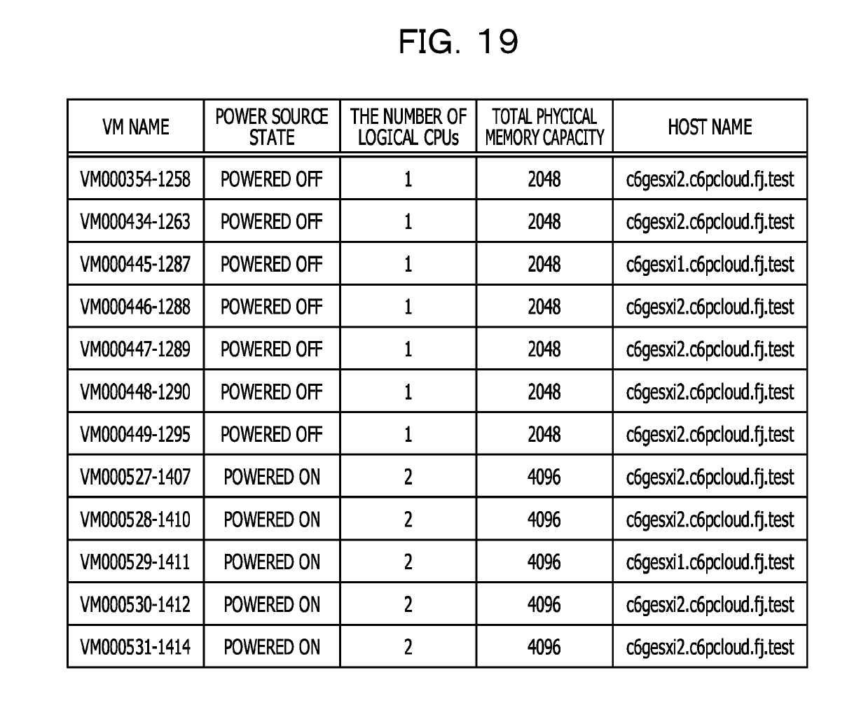

FIG. 19 illustrates an example of the memory assignment information stored in the first data storage unit 105. In the example in FIG. 19, a VM name, information indicating the state of the power source, the number of logical CPUs, the total physical memory capacity, and a host name are stored. The number of logical CPUs is the number of logical CPUs that are assigned to the virtual machine. The total physical memory capacity is the total amount of the physical memory capacity to be assigned to the virtual machine. However, for a virtual machine in a stop state, the total physical memory capacity is the total amount of the physical memory capacity scheduled to be assigned. The host name is a name of the physical machine 10 on which the virtual machine runs.

Returning back to FIG. 18, the calculation unit 106 calculates a memory capacity Aₘₙ available in the n time frame on the day of the week m using Aₘₙ =the physical memory capacity of the physical machine 10-Sₘₙ based on the physical machine information stored in the first data storage unit 105 (step S41).

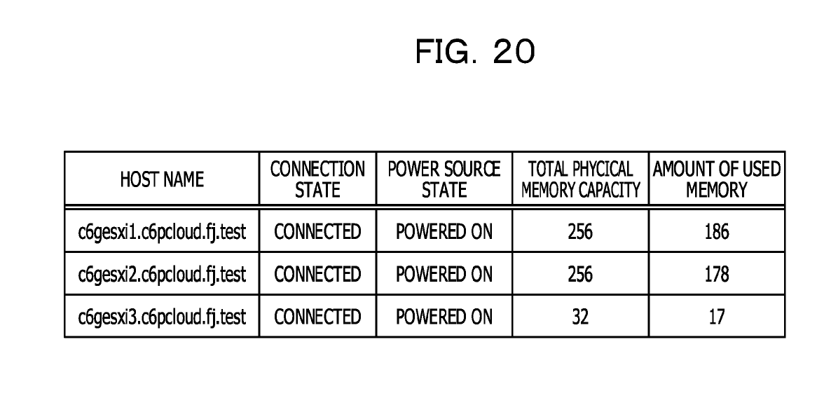

FIG. 20 illustrates an example of the physical machine information stored in the first data storage unit 105. In the example in FIG. 20, a host name, information indicating the connection state, information indicating the power source state, the total amount of the physical memory installed in the physical machine 10, and the amount of used memory at a certain point in time are stored.

Referring back to FIG. 18, the calculation unit 106 increments n by 1 (step S43), and determines whether or not n>23 holds (step S45). If n>23 does not hold (step S45: No route), the processing returns to the processing of step S37. On the other hand, if n>23 holds (step S45: Yes route), the extraction unit 107 increments m by 1, sets n to 0 (step S47), and determines whether or not m>7 holds (step S49).

If m>7 does not hold (step S49: No route), the processing returns to the processing of step S37. On the other hand, if m>7 holds (step S49: Yes route), the processing returns to the calling source processing (FIG. 6).

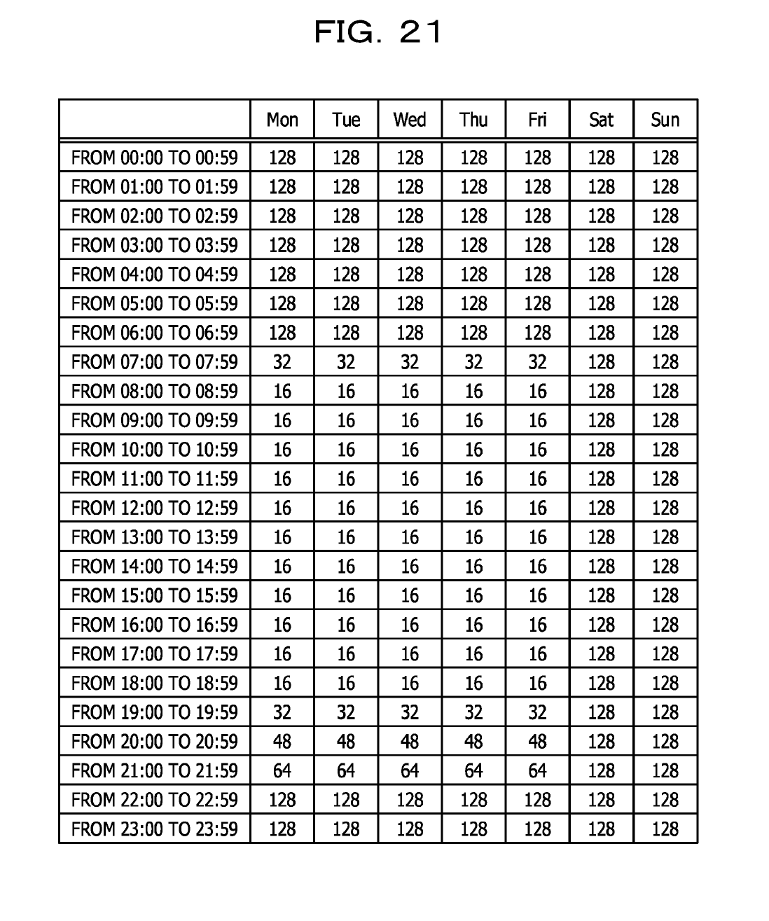

By executing the processing described above, for example, as illustrated in FIG. 21, memory capacity data available in each time frame on each day of the week (hereinafter referred to as memory capacity data) is generated. The unit is in gigabytes. The generated memory capacity data is passed to the determination unit 102.

Referring back to FIG. 6, the determination unit 102 determines whether or not Aₘₙ is larger than the memory capacity to be assigned to the new virtual machine in all the time frames on all the days of the week based on the memory capacity data generated in the calculation processing, and information on the memory capacity to be assigned to the new virtual machine, which was received from the schedule management unit 103 (step S5). In this regard, if the deployment request includes data that specifies a time frame in which the new virtual machine is operated, a comparison may be made only for that time frame. Thereby, it becomes possible to effectively use the memory resource.

If Aₘₙ is larger than the memory capacity to be assigned to the new virtual machine in all the time frames on all the days of the week (step S5: Yes route), the schedule management unit 103 outputs a start instruction of the virtual machine specified by the deployment request to the virtual infrastructure 101. In response to this, the virtual infrastructure 101 starts the virtual machine in accordance with the start instruction (step S7). The processing is then terminated.

On the other hand, if Aₘₙ is less than or equal to the memory capacity to be assigned to the new virtual machine in any one of the time frames (step S5: No route), the schedule management unit 103 generates a message indicating that it is not possible to start the virtual machine specified in the deployment request and transmits the message to the user terminal 5 (step S9). The processing is then terminated. In this regard, if it is possible to start the new virtual machine by reducing the memory capacity assigned to the new virtual machine, or by limiting the time frame, the information indicating that may be added to the message.

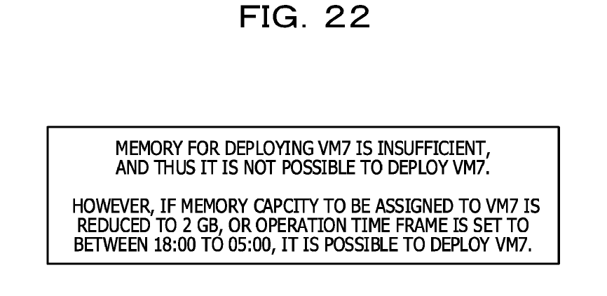

The user terminal 5 displays the received message on a display device, such as a display, or the like. FIG. 22 illustrates an example of a message to be displayed on the display device of the user terminal 5. The user confirms such a message so that it is possible for the user to take suitable measures, for example, to start a new machine at the other timing, to adjust the memory capacity to be assigned, or the like.

By executing the processing as described above, it becomes possible to effectively use the resources of the physical machine 10 while avoiding the occurrence of performance deterioration due to memory over-commitment. In particular, the user does not have to perform operation, such as avoiding memory over-commitment by assigning a larger capacity of memory to each virtual machine.

Also, if a large amount of memory that has been assigned to a virtual machine for a certain project is released along with the end of the project, it becomes possible to promptly assign the large amount of released memory to another virtual machine. In contrast, with the technique that determines the assignment of memory based on the peak value of the amount of used memory, for example, it is not possible to effectively use the released memory until confirmation is made on a decrease of the peak value of the amount of used memory the next day.

In the above, a description has been given of an embodiment of the present disclosure. However, the present disclosure is not limited to this. For example, the functional block configuration of the physical machine 10 described above sometimes does not match the actual program module configuration.

Also, the structure of each table described above is an example, and the structure does not have to be as described above. Further, in the processing flows, it is possible to change the orders of the processing unless the processing result does not change. Further, the processing may be executed in parallel.

For example, the virtual infrastructure 101 and a virtual machine that operates on the virtual infrastructure 101 may be distributed on a plurality of physical machines 10. Also, the virtual infrastructure 101 and a physical machine 10 on which the virtual infrastructure 101 is executed may be different from the physical machine 10 on which the other parts are executed.

Also, the operation prediction data may be generated using only the data of the CPU use rate.

The embodiment of the present disclosure described above is summarized as follows.

A control method according to the present embodiment includes processing of (A) acquiring operation information indicating a timing when a virtual machine started on an information processing device, and a timing when the virtual machine ended its operation, (B) making operation predictions of the virtual machine on the information processing device for each predetermined period based on the acquired operation information, (C) if a start of a new virtual machine on the information processing device is requested, determining whether or not to permit the start of the new virtual machine for the predetermined period based on a result of the operation prediction.

In this manner, it is possible to avoid starting a virtual machine with exceeding a permissible limit, and thus it becomes possible to restrain depletion of resources in the operation environment of the virtual machine.

Also, the processing for performing operation prediction of a virtual machine may include (b1) generating second operation information indicating a start timing of the virtual machine and an end timing of the operation of the virtual machine in a predetermined period from the obtained operation information, (b2) calculating a memory capacity to be used by the information processing device in the predetermined period based on the generated second operation information, and the memory capacity to be assigned to each virtual machine, and (b3) calculating an available memory capacity in a predetermined period from the memory capacity of the information processing device, and the memory capacity used by the information processing device in the predetermined period. In this manner, it becomes possible to restrain depletion of resources in an operation environment of a virtual machine.

Also, in the processing to determine whether or not to permit to start a new virtual machine, (c1) a determination may be made whether or not to permit to start the new virtual machine in a predetermined period based on a comparison between the calculated available memory capacity and the memory capacity assigned to the new virtual machine all the time in a predetermined period. In this manner, it becomes possible to restrain the occurrence of memory over-commitment.

Also, the present control method may further include processing for (D) determining whether or not at least a part of the operation information is missing, (E) if determined that at least a part of the operation information is missing, determining whether or not a virtual machine is in operation in a period corresponding to the missing part based on the information of the use rate of the processor of the information processing device, (F) if determined that the virtual machine is in operation in the period corresponding to the missing part, generating data to complement the missing part, and adding the data to the operation information. In this manner, it becomes possible to cope with a situation in which at least a part of the operation information has been missing due to a failure, or the like.

In this regard, it is possible to create a program for causing a computer to perform the processing by the above-described method. The program is stored in a computer-readable storage medium or a storage device, such as a flexible disk, a CD-ROM, a magneto-optical disc, a semiconductor memory, a hard disk, or the like, for example. In this regard, an intermediate processing result is temporarily stored in a storage device, such as a main memory, or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control method comprising:
acquiring result information including first timings and second timings, the first timings indicating time when each of a plurality of virtual machines started on an information processing device, and the second timings indicating time when each of the plurality of virtual machines ended;
executing predictions regarding each of the plurality of virtual machines running on the information processing device, for each of periods, based on the result information;
when a start of a new virtual machine on the information processing device is requested, determining for each of the periods whether the start of the new virtual machine is permitted based on a result of the predictions, by a processor; and
when it is determined that the start is permitted, starting the new virtual machine on the information processing device.

2. The control method according to claim 1,
wherein the predictions indicate whether or not the plurality of virtual machines are operating at each time on each day of a week.

3. The control method according to claim 2,
wherein the result information indicates the first timings and the second timings of the plurality of virtual machines at the each time on the each day of the week.

4. The control method according to claim 3, further comprising:
calculating a first amount of a memory in the information processing device based on the result information and a memory capacity assigned to each of the plurality of virtual machines, the first amount indicating memory amount used by the plurality of virtual machines at the each time on the each day of the week; and
calculating a second amount of the memory assignable to the new virtual machine at each time on the each day of the week based on a physical quantity of the memory and the first amount.

5. The control method according to claim 4, further comprising:
accepting a request for starting the new virtual machine, the request including a desired amount of the memory to be assigned to the new virtual machine; and
determining whether or not to permit to start the new virtual machine at the each time on the each day of the week based on a comparison between the second amount and the desired amount.

6. The control method according to claim 1, further comprising:
determining whether or not at least a part of the result information is missing;
when it is determined that at least a part of the result information is missing, generating data complementing the missing part based on a use rate of the processor of the information processing device; and
adding the data to the result information.

7. A non-transitory computer-readable storage medium storing a control program, when executed, causing a computer to executing a process, the process comprising:
acquiring result information including first timings and second timings, the first timings indicating time when each of a plurality of virtual machines started on an information processing device, and the second timings indicating time when each of the plurality of virtual machines ended;
executing predictions regarding each of the plurality of virtual machines running on the information processing device, for each of periods, based on the result information;
when a start of a new virtual machine on the information processing device is requested, determining for each of the periods whether the start of the new virtual machine is permitted based on a result of the predictions; and
when it is determined that the start is permitted, starting the new virtual machine on the information processing device.

8. The non-transitory computer-readable storage medium according to claim 7,
wherein the predictions indicate whether or not the plurality of virtual machines are operating at each time on each day of a week.

9. The non-transitory computer-readable storage medium according to claim 8,
wherein the result information indicates the first timings and the second timings of the plurality of virtual machines at the each time on the each day of the week.

10. The non-transitory computer-readable storage medium according to claim 9, the process further comprising:
calculating a first amount of a memory in the information processing device based on the result information and a memory capacity assigned to each of the plurality of virtual machines, the first amount indicating memory amount used by the plurality of virtual machines at the each time on the each day of the week; and
calculating a second amount of the memory assignable to the new virtual machine at each time on the each day of the week based on a physical quantity of the memory and the first amount.

11. The non-transitory computer-readable storage medium according to claim 10, the process further comprising:
accepting a request for starting the new virtual machine, the request including a desired amount of the memory to be assigned to the new virtual machine; and
determining whether or not to permit to start the new virtual machine at the each time on the each day of the week based on a comparison between the second amount and the desired amount.

12. The non-transitory computer-readable storage medium according to claim 7, the process further comprising:
determining whether or not at least a part of the result information is missing;
when it is determined that at least a part of the result information is missing, generating data complementing the missing part based on a use rate of the processor of the information processing device; and
adding the data to the result information.

13. A control device comprising:
a memory; and
a processor coupled to the memory and configured to:
acquire result information including first timings and second timings, the first timings indicating time when each of a plurality of virtual machines started on an information processing device, and the second timings indicating time when each of the plurality of virtual machines ended,
execute predictions regarding each of the plurality of virtual machines running on the information processing device, for each of periods, based on the result information,
when a start of a new virtual machine on the information processing device is requested, determine for each of the periods whether the start of the new virtual machine is permitted based on a result of the predictions, and
when it is determined that the start is permitted, start the new virtual machine on the information processing device.

14. The control device according to claim 13,
wherein the predictions indicate whether or not the plurality of virtual machines are operating at each time on each day of a week.

15. The control device according to claim 14,
wherein the result information indicates the first timings and the second timings of the plurality of virtual machines at the each time on the each day of the week.

16. The control device according to claim 15, wherein the processor is configured to:
calculate a first amount of a memory in the information processing device based on the result information and a memory capacity assigned to each of the plurality of virtual machines, the first amount indicating memory amount used by the plurality of virtual machines at the each time on the each day of the week, and
calculate a second amount of the memory assignable to the new virtual machine at each time on the each day of the week based on a physical quantity of the memory and the first amount.

17. The control device according to claim 16, wherein the processor is configured to:
accept a request for starting the new virtual machine, the request including a desired amount of the memory to be assigned to the new virtual machine, and
determine whether or not to permit to start the new virtual machine at the each time on the each day of the week based on a comparison between the second amount and the desired amount.

18. The control device according to claim 13, wherein the processor is configured to:
determine whether or not at least a part of the result information is missing,
when it is determined that at least a part of the result information is missing, generate data complementing the missing part based on a use rate of the processor of the information processing device, and
add the data to the result information.
